(19) United States
(12) Patent Application Publication
(10) Pub. No.: US 2025/0014035 A1
(43) Pub. Date: Jan. 9, 2025

(54) INFORMATION PROCESSING APPARATUS AND SYSTEM

(71) Applicant: TOYOTA JIDOSHA KABUSHIKI KAISHA, Aichi-ken (JP)

(72) Inventor: Minoru HAKII, Tokyo (JP)

(21) Appl. No.: 18/764,203

(22) Filed: Jul. 4, 2024

(30) Foreign Application Priority Data
Jul. 7, 2023 (JP) 2023-112434

(51) Int. Cl. G06Q 20/40

(52) U.S. Cl. CPC G06Q 20/401

(57) ABSTRACT

An information processing apparatus comprises a controller comprising at least one processor configured to perform: acquiring a payment account linked with a first user, a user ID of a second user different from the first user, and first product information; determining based on the user ID of the second user whether utilization authority for payment means linked with the payment account is given to the second user; determining whether the first product belongs to a first product category that is a product category, for which purchase by the second user is disapproved of, if the controller determines that the utilization authority for the payment means is given to the second user; and transmitting a signal indicating that payment processing for the first product utilizing the payment means is not permitted, if the controller determines that the first product belongs to the first product category.

### CROSS REFERENCE TO THE RELATED APPLICATION

This application claims the benefit of Japanese Patent Application No. 2023-112434, filed on Jul. 7, 2023, which is hereby incorporated by reference herein in its entirety.

### BACKGROUND

### Technical Field

The present disclosure relates to a payment system.

### Description of the Related Art

There are known many techniques for making payment using an account linked with a user.

In relation to this, for example, an authentication processing apparatus which pays for a product using an account of a first user if authentication of a second user which is authorized to utilize at least a part of the account of the first user is successful, and the like are disclosed in Japanese Patent Laid-Open No. 2021-26317.

### SUMMARY

The present disclosure has as its object to set a limit on payment in a case where a second user purchases a product through utilization of payment means linked with a first user.

The present disclosure in its one aspect provides an information processing apparatus comprising a controller comprising at least one processor configured to perform:
acquiring a payment account linked with a first user, a user ID of a second user different from the first user, and first product information including product information of a first product;
determining based on the user ID of the second user whether utilization authority for payment means linked with the payment account is given to the second user by the first user;
determining based on the user ID of the second user and the first product information whether the first product belongs to a first product category that is a product category, for which purchase by the second user is disapproved of, if the controller determines that the utilization authority for the payment means is given to the second user; and
transmitting a signal indicating that payment processing for the first product utilizing the payment means is not permitted to a store terminal of a first store where the second user is about to purchase the first product, if the controller determines that the first product belongs to the first product category.

The present disclosure in its another aspect provides an system comprising a server apparatus and a store terminal, wherein the server apparatus is configured to execute
acquiring a payment account linked with a first user, a user ID of a second user different from the first user, and first product information including product information of a first product,
determining based on the user ID of the second user whether utilization authority for payment means linked with the payment account is given to the second user by the first user,
determining based on the user ID of the second user and the first product information whether the first product belongs to a first product category that is a product category, for which purchase by the second user is disapproved of, if the server apparatus determines that the utilization authority for the payment means is given to the second user, and
transmitting a signal indicating that payment processing for the first product utilizing the payment means is not permitted to the store terminal of a first store where the second user is about to purchase the first product, if the server apparatus determines that the first product belongs to the first product category.

Other aspects include a method to be implemented by the above-described apparatus, a program for causing a computer to execute the method, or a computer-readable storage medium non-transitorily storing the program.

According to the present disclosure, it is possible to set a limit on payment in a case where the second user purchases a product by utilizing the payment means linked with the first user.

### BRIEF DESCRIPTION OF THE DRAWINGS

FIG. 1 is a conceptual diagram of a process to be executed by a server apparatus according to an embodiment;

FIG. 2 is a diagram for explaining constituent elements which a system including the server apparatus according to the embodiment has;

FIG. 3 is a flowchart of a process to be executed by the controller of the server apparatus according to the embodiment;

FIG. 4 is a flowchart of a payment limitation process based on an upper limit amount of money for a first product to be executed by the controller of the server apparatus according to the embodiment; and

FIG. 5 is a flowchart of a payment limitation process based on allergen information of the first product to be executed by the controller of the server apparatus according to the embodiment.

### DESCRIPTION OF THE EMBODIMENTS

There is known a payment processing system which authenticates a second user linked with a payment account of a first user to allow the authenticated second user to make payment with payment means linked with the payment account of the first user.

For example, consider a case where a child performs payment processing using a payment account of a parent. If a product or a service is purchased through an account of the child, payment may be made using the payment account of the parent that is linked with the account of the child. Specifically, the payment account of the parent is linked with the account of the child, payment for the product or the service purchased through the account of the child may be made with a credit card which is registered with the payment account of the parent.

However, if a product or a service can be paid for using payment means linked with the payment account of the parent through the account of the child, the child may be able to purchase, without permission, a product or a service which is determined by the parent to be inappropriate for the child to purchase. For example, a situation where an underage child purchases an alcohol beverage may occur.

It is preferable to, in a case as described above where a child is about to purchase an undesirable product, limit purchase of the product at the time of payment.

In the present disclosure, when a second user corresponding to a child is about to purchase a product coming under a product category, for which a first user corresponding to a parent disapproves of purchase, a server apparatus transmits, to a store terminal, a signal indicating that payment processing for the product with payment means linked with a payment account of the first user is not permitted, thereby solving the above-described problem.

The present disclosure in its one (another) aspect provides an information processing apparatus comprising a controller comprising at least one processor configured to perform:
acquiring a payment account linked with a first user, a user ID of a second user different from the first user, and first product information including product information of a first product;
determining based on the user ID of the second user whether utilization authority for payment means linked with the payment account is given to the second user by the first user;
determining based on the user ID of the second user and the first product information whether the first product belongs to a first product category that is a product category, for which purchase by the second user is disapproved of, if the controller determines that the utilization authority for the payment means is given to the second user; and
transmitting a signal indicating that payment processing for the first product utilizing the payment means is not permitted to a store terminal of a first store where the second user is about to purchase the first product, if the controller determines that the first product belongs to the first product category.

The payment account is an account with which information for identification of an individual user and various types of cashless services for the user to make payment are linked used when the user purchases a product or a service. For example, a face of the user may be registered with the payment account, and payment processing for a product or a service may be automatically performed using a cashless service linked with personal information of the user by authentication of the user's face at the time of checkout.

The first product category is a product category, for which the first user has decided not to permit purchase by the second user. The second user is prohibited by the first user from purchasing a product coming under the first product category.

The controller determines whether the first product that the second user is about to purchase belongs to the first product category, for which the first user does not permit purchase by the second user.

The controller transmits a signal prohibiting the second user from performing the payment processing for the first product using the payment means linked with the payment account of the first user to the store terminal if the controller determines that the first product belongs to the first product category.

The store terminal is a terminal which is a constituent of a POS (point of sales) system and is a terminal which performs information processing for customers to check out at a store. For example, the store terminal authenticates a card or a mobile terminal for cashless payment.

With the above-described configuration, if the second user is about to purchase a product or the like, purchase of which is prohibited by the first user, the information processing apparatus can prohibit payment for the product by the second user. Thus, the information processing apparatus can limit purchase of an undesirable product by the second user through utilization of the payment means for the account of the first user.

Note that, if the controller determines that the utilization authority for the payment means is given to the second user, the controller may further determine based on the user ID of the second user and the first product information whether the first product belongs to a second product category that is a product category, for which an upper limit amount for purchase by the second user is defined, and a price of the first product exceeds the upper limit amount. If it is determined that the first product belongs to the second product category and that the price of the first product exceeds the upper limit amount, a signal indicating that the payment processing for the first product utilizing the payment means is not permitted may be transmitted to the store terminal at the first store.

The second product category is a product category, for which purchase by the second user is permitted by the first user and for which an upper limit for a purchase amount is defined. The second user is prohibited by the first user from purchasing a product (products) coming under the second product category for the upper limit amount or more.

For the above-described reason, the information processing apparatus can prohibit the second user from paying for a product worth over the upper limit amount decided by the first user in a case where the second user is about to purchase the product. Thus, the information processing apparatus can limit purchase of a high-priced product by the second user through utilization of the payment means for the account of the first user.

If the first product includes a plurality of first products, the controller may determine a category to which the plurality of first products belong and whether a sum of prices of the plurality of first products which belong to the second product category exceeds the upper limit amount, and if the controller determines that the sum of the prices of the ones of the plurality of first products which belong to the second product category exceeds the upper limit amount, the controller may transmit a signal indicating that payment processing for the ones of the plurality of first products utilizing the payment means is not permitted to the store terminal at the first store.

For the above-described reason, the information processing apparatus can prohibit the second user from paying for a plurality of products for over the upper limit amount decided by the first user in a case where the second user is about to purchase the products. Thus, the information processing apparatus can limit purchase of products in a particular category for a large amount by the second user through utilization of the payment means for the account of the first user.

A storage configured to store allergen information that is information on an allergenic substance for the second user may be further provided, if the controller determines that the utilization authority for the payment means is given to the second user, the controller may further acquire raw material information that is information indicating a raw material for the first product, and determine based on the allergen information and the raw material information whether the allergenic substance for the second user is contained in the raw material for the first product, and if the controller determines that the allergenic substance for the second user is contained in the raw material for the first product, the controller may transmit a signal indicating that the payment processing for the first product utilizing the payment means is not permitted to the store terminal at the first store.

The raw material information is information representing all of raw materials which constitute the first product.

The allergen information is information indicating an allergenic substance which may cause allergies in the second user.

For the above-described reason, the information processing apparatus can prohibit the second user from paying for a product containing the allergenic substance for the second user in a case where the second user is about to purchase the product. Thus, the information processing apparatus can limit purchase of a product containing the allergenic substance for the second user itself by the second user through utilization of the payment means for the account of the first user.

A specific embodiment of the present disclosure will be described below with reference to the drawings. A hardware configuration, a module configuration, a functional configuration, and the like described in each embodiment are not intended to limit a technical scope of the disclosure only thereto unless otherwise described.

### Embodiment

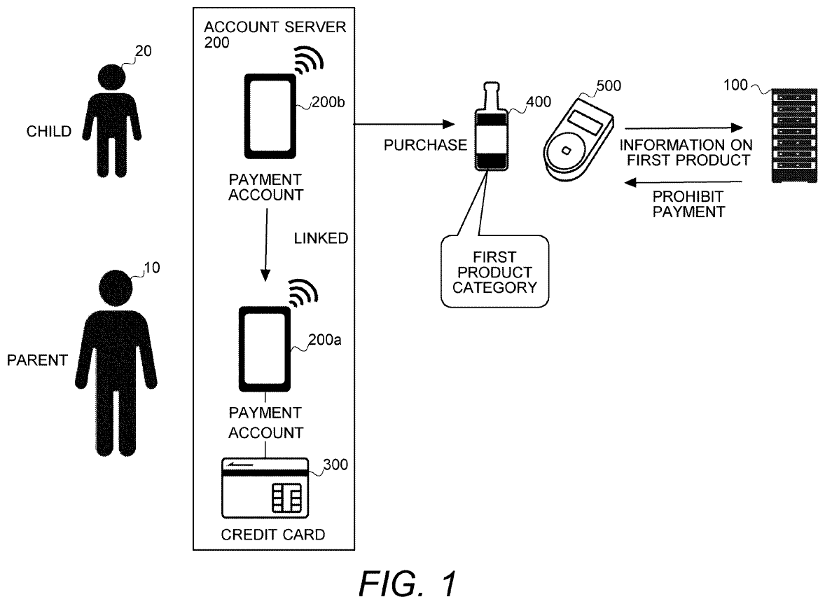

An outline of a process to be performed by an information processing apparatus according to an embodiment will be described with reference to FIG. 1. FIG. 1 is a conceptual diagram of a process to be executed by a server apparatus 100. In the present embodiment, the server apparatus 100 acquires information on a payment account 200a of a first user 10 and a payment account 200b of a second user 20 from an account server 200.

The payment account 200b of the second user 20 is configured to make payment with payment means (e.g., a credit card 300) which is linked with the payment account 200a of the first user 10.

The server apparatus 100 acquires, from a store terminal 500, information on a first product 400 which the second user 20 is about to purchase.

The server apparatus 100 also communicates with the store terminal 500 and transmits a signal indicating whether to permit payment processing by the second user 20 (i.e., payment processing utilizing the payment means linked with the payment account 200a of the first user 10) to the store terminal 500. Note that the payment means linked with the payment account 200a of the first user 10 that is to be utilized by the second user 20 will be referred to as first payment means hereinafter.

In the present embodiment, the payment account 200b of the second user 20 that is a child is linked with the payment account 200a of the first user 10 that is a parent. Information on the credit card 300, with which payment processing is performed, is linked with the payment account 200a of the first user 10. Since the payment account 200b of the second user 20 is linked with the payment account 200a of the first user 10, the payment processing through the payment account 200b of the second user 20 is performed using the credit card 300 linked with the payment account 200a of the first user 10. The server apparatus 100 communicates with the account server 200 and acquires information on the payment account 200a of the first user 10 and the payment account 200b of the second user 20.

The second user 20 that is the child checks out at a store to purchase the first product 400. At this time, the second user 20 is personally identified at a register through, for example, face authentication. Assume here that the first product 400 is, for example, alcohol.

The server apparatus 100 acquires a user ID of the second user 20 identified through, e.g., face authentication from the store terminal 500. The server apparatus 100 also acquires information on the first product 400 that the second user 20 is about to purchase from the store terminal 500 at a time when the second user 20 is about to pay for the first product 400.

The server apparatus 100 determines whether utilization authority for the first payment means is given to the second user 20. That is, the server apparatus 100 determines whether the second user 20 is permitted to perform payment processing through utilization of the first payment means. The server apparatus 100 communicates with the account server 200 and acquires information on whether the second user 20 is given the utilization authority for the first payment means by the first user 10.

If the server apparatus 100 determines that the second user 20 is given the utilization authority for the first payment means, the server apparatus 100 determines whether the first product 400 belongs to a first product category. The first product category here is a product category, for which the first user 10 has decided not to permit purchase by the second user 20. For example, if the first user 10 that is the parent prohibits the second user 20 that is the child from purchasing alcoholic beverages, the first product category is for alcoholic beverages. In this case, the first product 400 that is alcohol comes under the first product category. The server apparatus 100 may communicate with the account server 200 and acquire information on the first product category set by the first user 10.

If the server apparatus 100 determines that the first product 400 belongs to the first product category, the server apparatus 100 transmits a signal indicating that the second user 20 is not permitted to perform payment processing utilizing the first payment means to the store terminal 500. That is, if the server apparatus 100 determines that the first product 400 belongs to the first product category, the server apparatus 100 prohibits the second user 20 from performing payment processing for the first product 400 using the first payment means. The store terminal 500 here is a terminal for checkout which is installed at a store where the second user 20 is about to purchase the first product 400.

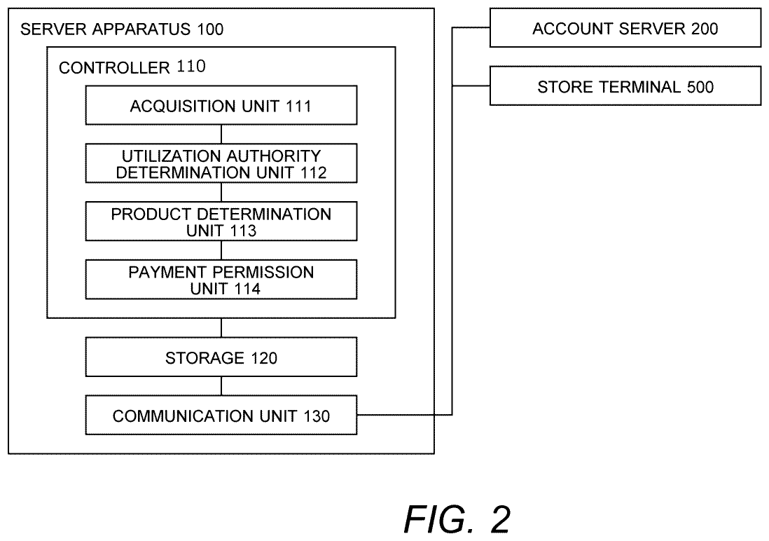

Elements which make up a system will be described in detail. FIG. 2 is a diagram for explaining constituent elements which a system including the server apparatus 100 according to the embodiment has.

The server apparatus 100 according to the present embodiment includes a controller 110, a storage 120, and a communication unit 130. The server apparatus 100 communicates with the account server 200 and acquires information needed for processing. The server apparatus 100 communicates with the store terminal 500, and transmits a signal indicating that payment processing is not permitted to the store terminal 500 if a predetermined condition is met. Note that the server apparatus 100 is an example of an information processing apparatus.

The controller 110 is implemented by a processor, such as a CPU (central processing unit) or a GPU (graphics processing unit), and a memory. The controller 110 includes, as functional modules, an acquisition unit 111, a utilization authority determination unit 112, a product determination unit 113, and a payment permission unit 114. These functional modules may be implemented through execution of a program by the controller 110.

The acquisition unit 111 acquires the user ID of the second user 20 and first product information from the store terminal 500 at a time when the second user 20 is about to pay for the first product 400 via the store terminal 500.

The first product information here is information as a set made up of a product ID of the first product 400, a product category for the first product 400, and a price of the first product 400. The product category is determined through reference to an external database by the server apparatus 100. If there are a plurality of first products 400, there may be a plurality of sets, each made up of a product ID, a product category, and a price, for the respective products.

The acquisition unit 111 communicates with the account server 200 via the communication unit 130 and acquires information on the payment account 200a of the first user 10. The acquisition unit 111 may acquire information on the credit card 300 linked with the payment account 200a of the first user 10 from the account server 200. The acquisition unit 111 may also acquire the payment account 200b of the second user 20 from the account server 200, instead of the user ID of the second user 20.

Alternatively, the acquisition unit 111 may acquire additional information on the first product 400 which is not included in the first product information from an external apparatus (e.g., a product database). The acquisition unit 111 can acquire information on what kind of the first product 400 the second user 20 is about to pay for by acquiring the first product information.

The acquisition unit 111 communicates with the external apparatus and acquires raw material information of the first product 400. The acquisition unit 111 also communicates with the account server 200 and acquires allergen information which is information on an allergenic substance for the second user 20.

The utilization authority determination unit 112 determines based on the user ID of the second user 20 whether the utilization authority for the payment means linked with the payment account 200a is given to the second user 20 by the first user 10. The utilization authority determination unit 112 may determine whether the payment account 200b of the second user 20 is permitted to perform payment processing with the credit card 300 linked with the payment account 200a of the first user 10.

The acquisition unit 111 also acquires, from the account server 200, information on the first product category (i.e., a product category, for which purchase by the second user 20 is prohibited by the first user 10) for the second user 20.

The product determination unit 113 determines based on the user ID of the second user 20 and the first product information whether the first product 400 belongs to the first product category. That is, the product determination unit 113 determines whether the first product 400 is a product belonging to a product category, for which purchase by the second user 20 is prohibited by the first user 10.

The product determination unit 113 determines based on the user ID of the second user 20 and the first product information whether the first product 400 belongs to a second product category and the price of the first product 400 exceeds an upper limit amount which is set in advance by the first user 10. The second product category here is a product category for which an upper limit amount for purchase by the second user 20 is defined. If there are a plurality of first products 400, the product determination unit 113 may determine whether the plurality of first products 400 belong to the second product category and determine whether the sum of prices of a plurality of first products 400 belonging to the second product category exceeds the upper limit amount.

The product determination unit 113 determines based on the allergen information and the raw material information whether the allergenic substance for the second user 20 is contained in raw materials for the first product 400.

The payment permission unit 114 prohibits the second user 20 from performing payment processing for the first product 400 using the first payment means if any of the three determination criteria described below is satisfied.

Firstly, the payment permission unit 114 transmits a signal indicating that payment processing for the first product 400 with the first payment means is not permitted to the store terminal 500 if the product determination unit 113 determines that the first product 400 belongs to the first product category. The store terminal 500 here is the store terminal 500 that is installed at a first store where the second user 20 is about to purchase the first product 400. That is, the payment permission unit 114 does not let the store terminal 500 perform payment processing for the first product 400 with the first payment means if the product determination unit 113 determines that the first product 400 belongs to the first product category.

Secondly, the payment permission unit 114 transmits a signal indicating that payment processing for the first product 400 with the first payment means is not permitted to the store terminal 500 at the first store if the product determination unit 113 determines that the first product 400 belongs to the second product category and that the price of the first product 400 exceeds the upper limit amount. Note that, if there are a plurality of first products 400 belonging to the second product category, the payment permission unit 114 may perform the process described earlier based on the sum of prices of the plurality of products.

Thirdly, the payment permission unit 114 transmits a signal indicating that payment processing for the first product 400 with the first payment means is not permitted to the store terminal 500 at the first store if the product determination unit 113 determines that the allergenic substance for the second user 20 is contained in the raw materials for the first product 400.

The storage 120 is a main memory, such as a RAM or a ROM, and an auxiliary memory, such as an EPROM, a hard disk drive, or a removable medium. An operating system (OS), various types of programs, various types of tables, and the like are stored in the auxiliary memory, and functions tailored to a predetermined purpose of the components of the controller 110 can be implemented through execution of a program stored therein. Note that some or all of the functions may be implemented by a hardware circuit, such as an ASIC or an FPGA.

The storage 120 stores data and the like used or generated by processing performed by the controller 110. For example, the storage 120 stores the payment account 200a of the first user 10 and the user ID of the second user 20. The storage 120 also stores the first product information and the allergen information.

The communication unit 130 is composed of a communication circuit which performs wireless communication. The communication unit 130 may be, for example, a communication circuit which performs wireless communication using 4G (4th generation) or a communication circuit which performs wireless communication using 5G (5th generation). The communication unit 130 may be a communication circuit which performs wireless communication using LTE (long term evolution) or a communication circuit which performs wireless communication based on LPWA (low power wide area). The communication unit 130 may be a communication circuit which performs wireless communication using Wi-Fi®.

An apparatus other than the server apparatus 100 will be described.

The account server 200 is a server apparatus which stores information on the payment account 200a of the first user 10 and the user ID of the second user 20. The account server 200 may store information on the credit card 300 linked with the payment account 200a of the first user 10.

The store terminal 500 is a terminal which is a constituent of a POS system and is a terminal which performs information processing for customers to check out at a store. For example, the store terminal 500 authenticates a card or a mobile terminal for cashless payment. The store terminal 500 may have a face authentication function. The store terminal 500 may execute payment processing using the payment account 200b linked with the second user 20 by authenticating a face of the second user 20 and identifying the second user 20 instead of authenticating a card or a mobile terminal for cashless payment. Note that, if the payment account 200b linked with the second user 20 or the user ID of the second user 20 is linked with the payment account 200a of the first user 10, the store terminal 500 may perform payment processing using the first payment means when the face of the second user 20 is authenticated.

The store terminal 500 transmits the user ID of the second user 20 and the first product information to the server apparatus 100 at a time when the second user 20 is about to pay for the first product 400. The store terminal 500 receives, from the server apparatus 100, information indicating whether to permit payment processing for the first product 400.

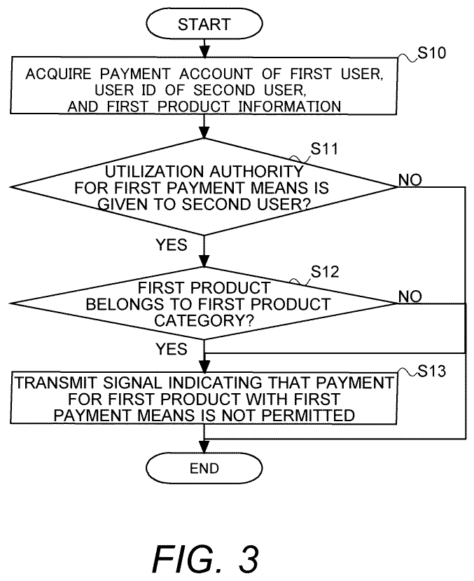

Specific details of a process to be performed by the server apparatus 100 will be described. FIG. 3 is a flowchart of a process to be executed by the controller 110 of the server apparatus 100 according to the embodiment.

Assume that the payment account 200a of the first user 10 and the user ID of the second user 20 are recorded in the account server 200 before the process illustrated in FIG. 3 is started. Assume also that additional information (e.g., the raw material information) on the first product 400 is recorded in an external apparatus which is capable of communicating with the server apparatus 100.

When the first product 400 is scanned with a checkout apparatus which the store terminal 500 has, and a payment amount is determined, the process in FIG. 3 starts. The checkout apparatus here is an apparatus for acquiring information on details of or an amount for a product by reading a barcode or the like of the product. When the above-described process is performed by the checkout apparatus, the store terminal 500 authenticates the second user 20 through, e.g., face authentication. At this time, the store terminal 500 generates the user ID of the second user 20 and the first product information.

First, in step S10, the acquisition unit 111 acquires the payment account 200a of the first user 10, the user ID of the second user 20, and the first product information. The acquisition unit 111 acquires, from the store terminal 500, the user ID of the second user 20 that is authenticated by the store terminal 500. The acquisition unit 111 also communicates with the account server 200 and acquires the payment account 200a of the first user 10 linked with the user ID of the second user 20. The acquisition unit 111 may acquire the user ID of the second user 20 that is identified through face authentication from corresponding information of the account server 200.

Next, in step S11, the utilization authority determination unit 112 determines whether the utilization authority for the first payment means is given to the second user 20. Specifically, the utilization authority determination unit 112 determines, based on information registered in the account server 200 on an object, for which the utilization authority for the first payment means is given by the first user 10, whether the utilization authority for the first payment means is given to the second user 20. At this time, the acquisition unit 111 acquires the information on the object, for which the utilization authority for the first payment means is given by the first user 10, that is acquired from the account server 200.

If the utilization authority determination unit 112 determines that the utilization authority for the first payment means is given to the second user 20, an affirmative determination is made in the present step.

If an affirmative determination is made in the present step, the process shifts to step S12.

If a negative determination is made in the present step, the process shifts to step S13.

If the process shifts to step S12, the product determination unit 113 determines whether the first product 400 belongs to the first product category. The product determination unit 113 determines based on information on the first product category whether the first product 400 matches a product coming under the first product category. If the first product 400 matches the product, the first product 400 may be determined to belong to the first product category.

If the product determination unit 113 determines that the first product 400 belongs to the first product category, an affirmative determination is made in the present step.

If an affirmative determination is made in the present step, the process shifts to step S13.

If a negative determination is made in the present step, the process ends.

If the process shifts to step S13, the payment permission unit 114 transmits a signal indicating that payment for the first product 400 with the first payment means is not permitted to the store terminal 500. That is, the payment permission unit 114 does not let the store terminal 500 perform payment processing for the first product 400 through utilization of the first payment means.

A process in which the controller 110 limits payment processing for the first product 400 with the first payment means based on an upper limit amount for the first product 400 will be described.

In the process described with reference to FIG. 3, the server apparatus 100 determines based on whether the first product 400 belongs to a category, for which purchase by the second user 20 is limited, whether to prohibit payment for the first product 400.

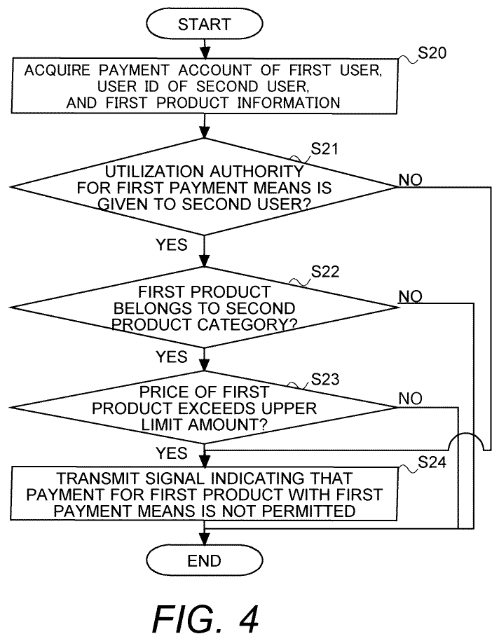

In a next process to be described with reference to FIG. 4, the server apparatus 100 prohibits payment processing if a purchase amount for the first product 400 by the second user 20 exceeds an upper limit amount which is set by the first user 10. The process to be described with reference to FIG. 4 is executed instead of the process described with reference to FIG. 3.

First, in step S20, the acquisition unit 111 acquires the payment account 200a of the first user 10, the user ID of the second user 20, and the first product information. The process in step S20 is the same as step S10 described with reference to FIG. 3.

Next, in step S21, the utilization authority determination unit 112 determines whether the utilization authority for the first payment means is given to the second user 20. The process in step S21 is the same as step S11 described with reference to FIG. 3.

If the utilization authority determination unit 112 determines that the utilization authority for the first payment means is given to the second user 20, an affirmative determination is made in the present step.

If an affirmative determination is made in the present step, the process shifts to step S22.

If a negative determination is made in the present step, the process shifts to S24.

If the process shifts to step S22, the product determination unit 113 determines whether the first product 400 belongs to the second product category. The second product category here is a product category, for which the first user 10 has defined an upper limit amount for purchase by the second user 20. The product determination unit 113 determines based on information on the second product category whether the first product 400 matches a product coming under the second product category. If the first product 400 matches the product, the first product 400 may be determined to belong to the second product category.

If the product determination unit 113 determines that the first product 400 belongs to the second product category, an affirmative determination is made in the present step.

If an affirmative determination is made in the present step, the process shifts to step S23.

If a negative determination is made in the present step, the process ends.

If the process shifts to step S23, the product determination unit 113 determines whether the price of the first product 400 exceeds the upper limit amount defined by the first user 10. If there are a plurality of first products 400, it may be determined whether a total amount of the plurality of first products 400 exceeds the upper limit amount.

If the product determination unit 113 determines that the price of the first product 400 exceeds the upper limit amount defined by the first user 10, an affirmative determination is made in the present step.

If an affirmative determination is made in the present step, the process shifts to step S24.

If a negative determination is made in the present step, the process ends.

If the process shifts to step S24, the payment permission unit 114 transmits a signal indicating that payment for the first product 400 with the first payment means is not permitted to the store terminal 500. That is, the payment permission unit 114 does not let the store terminal 500 perform payment processing for the first product 400 using the first payment means.

Note that, if there are a plurality of first products 400, and a total amount of the plurality of first products 400 exceeds the upper limit amount, the payment permission unit 114 may permit payment only within the bounds of not exceeding the upper limit amount.

A process in which the controller 110 limits payment processing for the first product 400 with the first payment means based on allergen information of the second user 20 will be described.

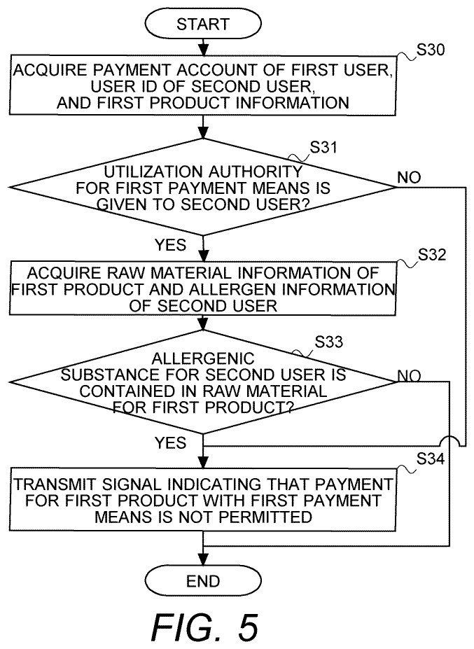

In a next process to be described with reference to FIG. 5, the server apparatus 100 determines whether the allergenic substance for the second user 20 is contained in the first product 400. The server apparatus 100 also prohibits performing payment for the first product 400 containing the allergenic substance with the first payment means. The process to be described with reference to FIG. 5 is executed instead of the process described with reference to FIG. 3.

First, in step S30, the acquisition unit 111 acquires the payment account 200a of the first user 10, the user ID of the second user 20, and the first product information. The process in step S30 is the same as step S10 described with reference to FIG. 3.

Next, in step S31, the utilization authority determination unit 112 determines whether the utilization authority for the first payment means is given to the second user 20. The process in step 31 is the same as step S11 described with reference to FIG. 3.

If the utilization authority determination unit 112 determines that the utilization authority for the first payment means is given to the second user 20, an affirmative determination is made in the present step.

If an affirmative determination is made in the present step, the process shifts to step S32.

If a negative determination is made in the present step, the process shifts to S34.

If the process shifts to step S32, the acquisition unit 111 acquires the raw material information of the first product 400 and the allergen information of the second user 20. The allergen information here is information on an allergenic substance which may cause allergies in the second user 20. The acquisition unit 111 communicates with the external apparatus via the communication unit 130 and acquires the raw material information of the first product 400. The acquisition unit 111 also communicates with the account server 200 via the communication unit 130 and acquires the allergen information of the second user 20.

Next, in step S33, the product determination unit 113 determines whether the allergenic substance for the second user 20 is contained in the raw materials for the first product 400. If a substance which is a constituent of the raw materials included in the raw material information of the first product 400 that is acquired by the acquisition unit 111 matches a substance included in the allergen information of the second user 20, the product determination unit 113 may determine that the allergenic substance for the second user 20 is contained in the raw materials for the first product 400.

If an affirmative determination is made in the present step, the process shifts to step S34.

If a negative determination is made in the present step, the process ends.

If the process shifts to step S34, the payment permission unit 114 transmits a signal indicating that payment for the first product 400 with the first payment means is not permitted to the store terminal 500. That is, the payment permission unit 114 does not let the store terminal 500 perform payment processing for the first product 400 using the first payment means.

As has been described above, the server apparatus 100 first determines whether the utilization authority for the first payment means is given to the second user 20. If the utilization authority for the first payment means is given to the second user 20, the server apparatus 100 determines whether the first product 400 that the second user 20 is about to purchase satisfies predetermined conditions.

The predetermined conditions are conditions on a product category, a total amount, whether an allergenic substance is contained, and the like, as described earlier.

If the first product 400 satisfies the predetermined conditions, the server apparatus 100 transmits a signal indicating that payment for the first product 400 with the first payment means is not permitted to the store terminal 500. This allows prohibition of payment for a product which the second user 20 is prohibited from purchasing and allows the second user 20 to be inhibited from purchasing a product contrary to the intention of the first user 10.

### Modifications

The above-described embodiment is just an example, and the present disclosure can be appropriately changed and implemented without departing from the spirit thereof.

For example, the processes and means described in the present disclosure can be freely combined and implemented unless a technical contradiction arises. The above embodiment is only an example, and the present disclosure can be appropriately modified and implemented within the scope of not departing from the gist. For example, the processes and means described in the present disclosure can be freely combined as long as there is no technical contradiction.

Further, the processing described as being performed by one device may be shared and performed by a plurality of devices. Alternatively, the processing described as being performed by different devices may be performed by one device. In the computer system, it is possible to flexibly change what kind of hardware configuration (server configuration) each function is realized.

The present disclosure can also be realized by supplying a computer program implementing the functions described in the above embodiment to a computer, and one or more processors included in the computer read out and execute the program. Such computer programs may be provided to a computer by a non-transitory computer-readable storage medium connectable to a system bus of the computer, or may be provided to the computer over a network. A non-transitory computer-readable storage medium includes, for example, any type of disk, such as a magnetic disk (floppy disk, hard disk drive (HDD), etc.), an optical disk (CD-ROM, DVD disk, Blu-ray disk, etc.), read-only memory (ROM), random access memory (RAM), EPROM, EEPROM, magnetic card, flash memory, optical card, any type of medium suitable for storing electronic instructions.

What is claimed is:

1. An information processing apparatus comprising a controller comprising at least one processor configured to perform:
acquiring a payment account linked with a first user, a user ID of a second user different from the first user, and first product information including product information of a first product;
determining based on the user ID of the second user whether utilization authority for payment means linked with the payment account is given to the second user by the first user;
determining based on the user ID of the second user and the first product information whether the first product belongs to a first product category that is a product category, for which purchase by the second user is disapproved of, if the controller determines that the utilization authority for the payment means is given to the second user; and
transmitting a signal indicating that payment processing for the first product utilizing the payment means is not permitted to a store terminal of a first store where the second user is about to purchase the first product, if the controller determines that the first product belongs to the first product category.

2. The information processing apparatus according to claim 1, wherein
if the controller determines that the utilization authority for the payment means is given to the second user,
the controller further determines based on the user ID of the second user and the first product information whether the first product belongs to a second product category that is a product category, for which an upper limit amount for purchase by the second user is defined, and a price of the first product exceeds the upper limit amount, and
if the controller determines that the first product belongs to the second product category and that the price of the first product exceeds the upper limit amount, the controller transmits a signal indicating that payment processing for the first product utilizing the payment means is not permitted to the store terminal at the first store.

3. The information processing apparatus according to claim 2, wherein
if the first product comprises a plurality of the first products,
the controller determines a category to which the plurality of the first products belong and whether a sum of prices of the plurality of the first products which belong to the second product category exceeds the upper limit amount, and
if the controller determines that the sum of the prices of the ones of the plurality of the first products which belong to the second product category exceeds the upper limit amount, the controller transmits a signal indicating that payment processing for the ones of the plurality of the first products utilizing the payment means is not permitted to the store terminal at the first store.

4. The information processing apparatus according to claim 1, further comprising
a storage configured to store allergen information that is information on an allergenic substance for the second user, wherein
if the controller determines that the utilization authority for the payment means is given to the second user,
the controller further acquires raw material information that is information indicating a raw material for the first product, and
determines based on the allergen information and the raw material information whether the allergenic substance for the second user is contained in the raw material for the first product, and
if the controller determines that the allergenic substance for the second user is contained in the raw material for the first product, the controller transmits a signal indicating that payment processing for the first product utilizing the payment means is not permitted to the store terminal at the first store.

5. A system comprising a server apparatus and a store terminal, wherein the server apparatus is configured to execute:
acquiring a payment account linked with a first user, a user ID of a second user different from the first user, and first product information including product information of a first product,
determining based on the user ID of the second user whether utilization authority for payment means linked with the payment account is given to the second user by the first user,
determining based on the user ID of the second user and the first product information whether the first product belongs to a first product category that is a product category, for which purchase by the second user is disapproved of, if the server apparatus determines that the utilization authority for the payment means is given to the second user, and
transmitting a signal indicating that payment processing for the first product utilizing the payment means is not permitted to the store terminal of a first store where the second user is about to purchase the first product, if the server apparatus determines that the first product belongs to the first product category.
